(19) United States
(12) Patent Application Publication
(10) Pub. No.: US 2021/0036577 A1
(43) Pub. Date: Feb. 4, 2021

(54) ELECTRIC MOTOR

(71) Applicant: Mitsubishi Electric Corporation, Tokyo (JP)

(72) Inventors: Haruyuki HASEGAWA, Tokyo (JP); Fumiaki TSUCHIYA, Tokyo (JP); Toshihiro TANAKA, Tokyo (JP)

(73) Assignee: Mitsubishi Electric Corporation, Tokyo (JP)

(21) Appl. No.: 17/043,674

(22) PCT Filed: Apr. 27, 2018
(86) PCT No.: PCT/JP2018/017309

§ 371 Date: Sep. 30, 2020

(51) Int. Cl. H02K 5/22; H02K 11/22; H02K 3/50; H02K 11/215

(52) U.S. Cl. CPC H02K 5/225; H02K 11/215; H02K 3/50; H02K 11/22

(57) ABSTRACT

An electric motor includes a stator and a rotor that is surrounded by the stator and rotates on a shaft. The electric motor includes a detector that detects a rotational position of the shaft and outputs an electrical signal indicative of a detection result, a detector cover housing the detector, a power line that is provided in the electric motor to transmit electric power that drives rotation of the rotor, a signal line that allows in the detector cover propagation of the electrical signal output from the detector, and a connector that is provided to the detector cover and is fitted with an end of the power line and an end of the signal line.

### FIELD

The present invention relates to an electric motor including a detector.

### BACKGROUND

Feedback control of rotative driving of an electric motor which includes a detector is performed based on a detection result of the detector. Such an electric motor is internally provided with a signal line that transmits, to a control device for the electric motor, an electrical signal indicative of the detection result of the detector, and a power line that transmits electric power supplied from the control device. The signal line provided in the electric motor is connected via a connector to a cable including a signal line external to the electric motor. Therefore, the electric motor can transmit, to the control device external to the electric motor, the signal output from the detector in the electric motor. The power line provided in the electric motor is connected via a connector to a cable including a power line external to the electric motor. Therefore, the electric motor can be supplied with electric power from the control device.

Patent Literature 1 discloses a cable in which a power line and a signal line are incorporated, and an electric motor with one connector to which the cable is connected. A signal line and a power line of the electric motor can be connected at the one connector, so that the electric motor enables its connection to an external control device to be simplified as work.

### CITATION LIST

### Patent Literature

Patent Literature 1: Japanese Patent Application Laid-open No. S61-171010

### SUMMARY

### Technical Problem

A very small current flows through the signal line as compared with a current that flows through the power line. Therefore, if noise included in the current flowing through the power line contaminates the current flowing through the signal line, it is difficult for a correct electrical signal to propagate toward the control device.

According to the technique described in Patent Literature 1, the power line and the signal line of the cable are electrically shielded by shields, so that outside the electric motor, an electrical signal propagating in the signal line is less contaminated by noise. However, in the electric motor, the power line and the signal line are grouped at the one connector, so that the noise can contaminate the electrical signal propagating in the signal line. Therefore, while connection of the signal lines and connection of the power lines are enabled at the one connector, the technique described in Patent Literature 1 is problematic in that the noise may contaminate the electrical signal indicative of a detection result of a detector.

The present invention has been made in view of the above, and an object of the present invention is to obtain an electric motor that enables connection of signal lines and connection of power lines at one connector and enables an electrical signal indicating a detection result of a detector to be less contaminated by noise.

### Solution to Problem

To solve the above-stated problem and achieve the object, an electric motor according to the present invention includes a stator and a rotor that is surrounded by the stator and rotates on a rotation shaft. The electric motor according to the present invention includes a detector that detects a rotational position of the shaft and outputs an electrical signal indicative of a detection result, a detector cover housing the detector, a power line that is provided in the electric motor to transmit electric power that drives rotation of the rotor, a signal line that allows in the detector cover propagation of the electrical signal output from the detector, and a connector that is provided to the detector cover and is fitted with an end of the power line and an end of the signal line.

### Advantageous Effects of Invention

The electric motor according to the present invention enables power line connection and signal line connection at the one connector and enables the electrical signal indicating the detection result of the detector to be less contaminated by noise.

### BRIEF DESCRIPTION OF DRAWINGS

FIG. 1 illustrates structure of an electric motor according to a first embodiment of the present invention.

FIG. 2 illustrates structure of an electric motor according to a modification of the first embodiment.

FIG. 3 illustrates structure of an electric motor according to a second embodiment of the present invention.

FIG. 4 illustrates structure of an electric motor according to a modification of the second embodiment.

### DESCRIPTION OF EMBODIMENTS

With reference to the drawings, a detailed description is hereinafter provided of electric motors according to embodiments of the present invention. It is to be noted that these embodiments are not restrictive of the present invention.

### First Embodiment

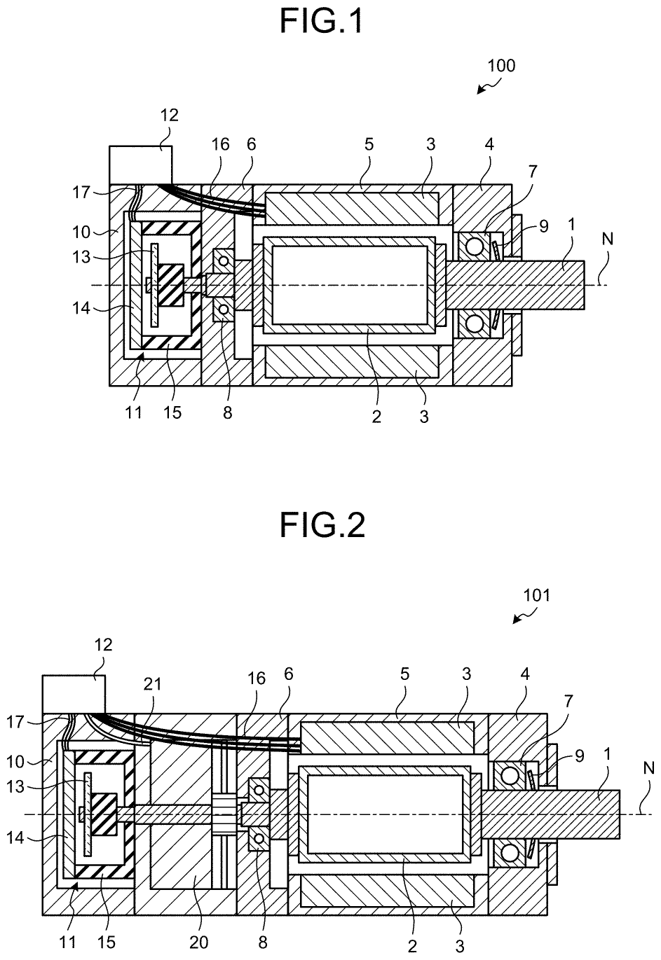

FIG. 1 illustrates structure of an electric motor 100 according to the first embodiment of the present invention. The electric motor 100 is a servomotor with enabled feedback control based on a result of rotation detection of the electric motor 100. In FIG. 1, a section of the structure is schematically illustrated including an axis N. The axis N is a line representing a center of a shaft 1. In FIG. 1, a right-hand side of the electric motor 100 is a load side to which a load is connected, while a left-hand side of the electric motor 100 is a counter load side.

The electric motor 100 includes a stator 3 and a rotor 2 that is surrounded by the stator 3 and rotates on the shaft 1. A current flows through the stator 3 of the electric motor 100 to produce a magnetic field that is closer to the axis N than the stator 3. The rotor 2 is rotatively driven by interaction between the magnetic field produced by the stator 3 and a magnetic field produced by the rotor 2. The shaft 1 is rotated together with the rotor 2 of the electric motor 100. In this way, torque of the rotor 2 is transmitted out of the electric motor 100.

A first bracket 4, a frame 5, a second bracket 6, and a detector cover 10 compose an outer shell of the electric motor 100. The stator 3 is press-fitted to the frame 5. The first bracket 4 is provided closer to the load side than the frame 5 is. A first bearing 7 is disposed inside the first bracket 4. The shaft 1 is rotatably supported by the first bearing 7 that is closer to the load side than the rotor 2 is. The second bracket 6 is provided closer to the counter load side than the frame 5 is. The shaft 1 is rotatably supported by a second bearing 8 that is closer to the counter load side than the rotor 2 is. A plate spring 9 is a preload spring provided in a clearance between the first bracket 4 and the first bearing 7. The plate spring 9 applies a preload to the first bearing 7 to reduce vibration of the first bearing 7.

The electric motor 100 includes a detector 11 that detects a rotational position of the shaft 1 and outputs an electrical signal indicative of a detection result, and a detector cover 10 housing the detector 11. The detector cover 10 is disposed closer to the counter load side than the second bracket 6 is. The detector cover 10 is a cylindrical body with its counter load-side end closed and has the shape of a circular cylinder. A load-side end of the detector cover 10 is closed with the second bracket 6.

The detector 11 includes a disk 13 mounted to the shaft 1, and a circuit board 14 which is circuitry that outputs the electrical signal indicative of the result of rotational position detection of the shaft 1. The rotational position represents an angle of rotation on the axis N. The detector 11 includes a housing 15 that covers a load-side surface of the circuit board 14 and houses the disk 13. The shaft 1 has a counter load-side end inserted into the housing 15. The disk 13 is mounted to this end of the shaft 1. The housing 15 is mounted to the second bracket 6, so that the detector 11 is supported in a space surrounded by the detector cover 10 and the second bracket 6.

The detector 11 is a rotary encoder that converts a mechanical displacement in rotation to an electrical signal and processes the electrical signal for detection of a rotational position. The detector 11 according to the first embodiment is an encoder of an optical type that detects light passing through or reflecting off the disk 13 and detects a rotational position of the shaft 1 on a basis of a detected pattern of the light. The detector 11 may be an encoder of a magnetic type that detects a rotational position of the shaft 1 on a basis of an electrical signal obtained by detecting a magnetic field which varies with rotation of a permanent magnet or an induction coil.

The electric motor 100 includes a power line 16 that transmits electric power to drive rotation of the rotor 2, and a signal line 17 that is a first signal line in which the electrical signal output from the circuit board 14 propagates in the detector cover 10. The power line 16 is provided in the electric motor 100. The electric motor 100 includes a connector 12 fitted with an end of the power line 16 and an end of the signal line 17. The detector cover 10 is provided with the connector 12 at its side surface which is a cylindrical surface.

The signal line 17 has one of its ends connected to the circuit board 14. The other end of the signal line 17 is connected to a terminal inside the connector 12. The signal line 17 is provided in the detector cover 10, extending between the circuit board 14 and the connector 12. The power line 16 has one of its ends connected to the stator 3. The other end of the power line 16 is connected to a terminal of the connector 12, and this terminal is positioned closer to the load side than the terminal connected to the signal line 17 is. The power line 16 is passed through the frame 5, the second bracket 6, and the detector cover 10, thus being provided between the stator 3 and the connector 12 in the electric motor 100. It is to be noted that internal structure of the connector 12 is not illustrated in FIG. 1. Inside the connector 12, the power line 16 and the signal line 17 are electrically shielded from each other, so that the electrical signal of the signal line 17 is less contaminated by noise from the power line 16. One kind of noise included in a current flowing through the power line 16 is switching noise that is caused by a driven inverter provided in a control device.

With the signal line 17 in the detector cover 10 being connected via the terminal inside the connector 12 to a signal line external to the electric motor 100, the electric motor 100 transmits the electrical signal output from its internal circuit board 14 to the control device external to the electric motor 100. With the power line 16 in the electric motor 100 being connected via the terminal inside the connector 12 to a power line external to the electric motor 100, the electric motor 100 can receive electric power from the control device. It is to be noted that the external signal line, the external power line, and the control device are not illustrated in FIG. 1. The external conductive line and the external signal line may be incorporated in one cable to be connected to the connector 12. A cable including the external conductive line and a cable including the external signal line may be connected to the connector 12 separately from each other.

In the first embodiment, the connector 12 is provided to the side surface of the detector cover 10, so that the terminal of the connector 12 that is connected to the signal line 17 can be in close proximity to a position of the circuit board 14 that is connected to the one end of the signal line 17. Having the shortest possible signal line 17 in the detector cover 10, the electric motor 100 thus can reduce a possibility of the noise contaminating the electrical signal that propagates in the signal line 17. Moreover, the signal line 17 can be disposed without being pulled out of the detector cover 10 and therefore can reduce a possibility that noise from the constituent element external to the detector cover 10 contaminates the electrical signal of the signal line 17 as compared to when the signal line 17 is pulled out of the detector cover 10. Furthermore, because the signal line 17 can be made short, the signal line 17 can be disposed compactly.

The connector 12 is fitted with the end of the power line 16 at the position that is closer to the load side than the position of the connector 12 where the signal line 17 is fitted is. Therefore, the power line 16 and the signal line 17 can be disposed in the electric motor 100 with the power line 16 not crossing or not being in close proximity to the signal line 17. Thus, the electric motor 100 enables the electrical signal of the signal line 17 to be less contaminated by the noise from the power line 16. With the power line 16 being positioned closer to the load side than the circuit board 14 is, the power line 16 and the signal line 17 thus disposed can be prevented from crossing each other.

Because of the disposition of the power line 16 and the signal line 17, the electric motor 100 enables the electrical signal of the signal line 17 to be less contaminated by the noise from the power line 16 even if the power line 16 and the signal line 17 are not each provided with an electrically shielding shield. When the power line 16 and the signal line 17 are each provided with the shield, because of their increased thicknesses, routing becomes time-consuming work compared to when no shields are provided. The electric motor 100 eliminates the need for shielding the power line 16 and the signal line 17, so that routing the power line 16 and the signal line 17 can be done as simple work as compared to when the shields are provided.

Because the electrical signal of the signal line 17 can be less contaminated by the noise, the electric motor 100 can accurately transmit the detection result of the detector 11 to the control device. Thus the electric motor 100 can be driven by high precision feedback control.

A material used for the detector cover 10 is aluminum which is a conductive material and is one of metallic materials. Instead of being made entirely of aluminum, the detector cover 10 may include a part that is made of a material other than a conductive material and is combined with aluminum. The detector cover 10 may have only its outer shell covered with aluminum. With the use of the metallic material that is conductive material as the material of the detector cover 10, the signal line 17 and the circuit board 14 can be less contaminated by the noise in the detector cover 10. Connecting the detector cover 10 to a ground electrode can effectively reduce contamination by the noise. In place of aluminum, another metallic material that is conductive material, or a conductive material that is not a metallic material may be used.

The material used for the detector cover 10 may be iron which is a ferromagnetic material and is one of the metallic materials. While being the ferromagnetic material, iron is also a conductive material. Instead of being made entirely of iron, the detector cover 10 may include a part that is made of a material other than a ferromagnetic material and is combined with iron. The detector cover 10 may be made by insert molding using iron and a resin material which is not a ferromagnetic material. With the use of the metallic material that is ferromagnetic material as the material of the detector cover 10, the signal line 17 and the circuit board 14 can be less contaminated by magnetic noise in the detector cover 10. In place of iron, another ferromagnetic material that is ferromagnetic material may be used. As with the detector cover 10, the second bracket 6 may also be made of a ferromagnetic material.

It is to be noted that the detector cover 10 is not limited to the one made of the conductive material or the ferromagnetic material. The detector cover 10 may be made without using the conductive material or the ferromagnetic material. The detector cover 10 may be made of a resin which is a material that is neither conductive material nor ferromagnetic material.

The connection of the power line 16 and the external power line and the connection of the signal line 17 and the external signal line can be collectively achieved at the one connector 12 of the electric motor 100. Therefore, the electric motor 100 enables its connection to the control device external to the electric motor 100 to be simplified as work.

According to the first embodiment, since the connector 12 is provided to the detector cover 10, the electric motor 100 has the shortest possible signal line 17, thus enabling the electrical signal to be less contaminated by the noise when propagating in the signal line 17. Therefore, while enabling the connection of the power line 16 and the connection of the signal line 17 at the one connector 12, the electric motor 100 enables the electrical signal indicating the detection result of the detector 11 to be less contaminated by the noise.

FIG. 2 illustrates structure of an electric motor 101 according to a modification of the first embodiment. The electric motor 101 according to the modification is not only similar in structure to the electric motor 100 illustrated in FIG. 1, but also is provided with a brake 20 that brakes rotation of the shaft 1, and a brake line 21 connected to the brake 20. The brake line 21 is a second signal line that allows propagation of an electrical signal from a control device. The second signal line refers to a signal line other than the signal line 17 among those signal lines provided in the electric motor 100. On a basis of the electrical signal from the control device, the brake 20 brakes and releases the shaft 1.

The brake line 21 has one end connected to the brake 20. The brake line 21 has another end connected to a terminal inside the connector 12. The brake line 21 is passed through the detector cover 10 to be provided between the brake 20 and the connector 12 in the electric motor 101. With the brake line 21 in the electric motor 101 being connected via the terminal inside the connector 12 to a brake line external to the electric motor 101, the electric motor 101 can receive the electrical signal from the control device. It is to be noted that the external brake line is not illustrated in FIG. 2.

In the connector 12, the terminal that is connected to the end of the brake line 21 can be disposed in any position. A current that flows through the brake line 21 is small compared with a current that flows through the power line 16, so that even when the brake line 21 is in close proximity to the signal line 17, an electrical signal propagating in the signal line 17 is less affected. Therefore, even the electric motor 101 according to the present modification enables the electrical signal indicating a detection result of the detector 11 to be less contaminated by noise.

Connection of the power line 16 and an external power line, connection of the signal line 17 and an external signal line, and the connection of the brake line 21 and the external brake line can be collectively achieved at the one connector 12 of the electric motor 101. Therefore, the electric motor 101 enables its connection to the control device external to the electric motor 101 to be simplified as work.

When the electric motor 101 is provided with a thermistor that measures temperature of the electric motor 101, a thermistor line connected to the thermistor may have an end also fitted to the connector 12 as with the brake line 21. The thermistor line is a second signal line that allows propagation of an electrical signal indicative of a result of temperature measurement. A current that flows through the thermistor line is also small compared with the current that flows through the power line 16, so that even when the thermistor line is in close proximity to the signal line 17, the electrical signal propagating in the signal line 17 is less affected. Therefore, the electric motor 101 enables the electrical signal indicating the detection result of the detector 11 to be less contaminated by noise. When a sensor other than the thermistor, such as a vibration sensor, is provided, in addition to the thermistor line, a second signal line that allows propagation of an electrical signal from this sensor may also be provided as with the brake line 21.

### Second Embodiment

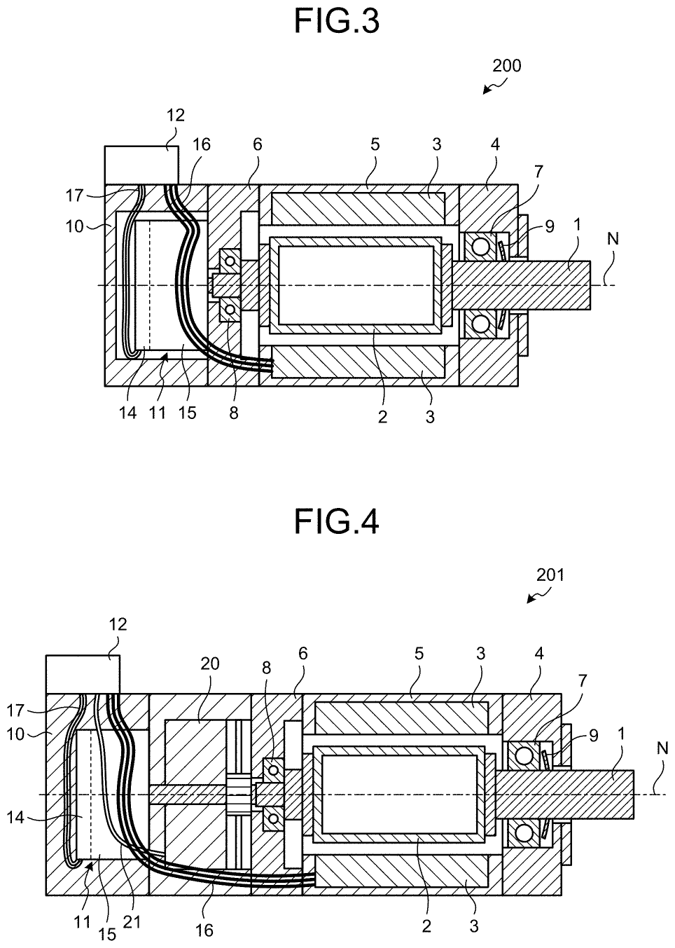

FIG. 3 illustrates structure of an electric motor 200 according to the second embodiment of the present invention. According to the second embodiment, in a position that is closer to a load side of the electric motor 200 than the circuit board 14 and the signal line 17 are, the power line 16 is wound onto a structure that is provided closer to a counter load side of the electric motor 200 than the stator 3 is. In the second embodiment, constituent elements identical with those in the above-described first embodiment have the same reference characters, and a description is provided mainly of structural differences from the first embodiment. In FIG. 3, a side of the detector 11 is illustrated, and the circuit board 14 included in the detector 11 is indicated by a broken line.

An interior of the detector cover 10 includes a space that is secured around the detector 11 to enable the power line 16 to be wound. The detector 11 is one of those structures provided closer to the counter load side than the stator 3 is. The power line 16 is passed through the second bracket 6, that space, and the detector cover 10, thus being provided between the stator 3 and the connector 12 in the electric motor 200.

The interior of the detector cover 10 includes a space that is secured closer to the counter load side than the detector 11 is, thus enabling the signal line 17 to be disposed. The signal line 17 is passed through this space and the detector cover 10, thus being provided between the circuit board 14 and the connector 12 in the detector cover 10.

For work, which is fitting of an end of the power line 16 pulled from the stator 3 to the connector 12, a length of the power line 16 includes an extension, which corresponds to a spare length, to be longer than a length corresponding to a shortest distance between the stator 3 and a terminal of the connector 12. The spare length corresponds to an excess portion of the power line 16 that is added to a portion corresponding to the shortest distance. This portion of the power line 16 corresponding to the spare length is passed around the detector 11 and is in a moderately tensioned condition. The moderately tensioned condition refers to a condition of being not slack enough to reach the signal line 17 or the circuit board 14, either of which is positioned closer to the counter load side than a position of the connector 12 fitted with the power line 16 is, as well as being not too tensioned to cause a problem to electrical connection of the power line 16.

When the electric motor 200 is assembled, the power line 16 pulled from the stator 3 is connected to the terminal of the connector 12. Here the detector cover 10 is not in a condition of being secured to the second bracket 6, but in a condition of being rotatable on the axis N relative to the second bracket 6. Since the portion corresponding to the spare length is secured for the power line 16, fitting the power line 16 can be done as easy work. It is to be noted that a portion corresponding to a spare length is also secured for the signal line 17 that is pulled from the circuit board 14.

After the power line 16 and the signal line 17 are connected to the terminal of the connector 12, the detector cover 10 is rotated relative to the second bracket 6. The end of the power line 16 fitted to the connector 12 moves relative to a portion of the power line 16 that is disposed closer to the load side than the second bracket 6 is. The power line 16 is accordingly wound around the detector 11 and is gradually tensioned. When the power line 16 is in the moderately tensioned condition, the rotation of the detector cover 10 is stopped. Thereafter, the detector cover 10 is secured to the second bracket 6 with the power line 16 wound onto the detector 11. It is to be noted that the power line 16 may be wound over a smaller or larger angular range than 360 degrees.

A length of the signal line 17 pulled from the circuit board 14 corresponds to a longest distance between a position of the circuit board 14 where an end of the signal line 17 is fitted and a position of the terminal of the connector 12. The longest distance is a distance between the position of the terminal of the connector 12 and the position of the circuit board 14 where the end of the signal line 17 is fitted when this circuit board's position is in a rotational position moved 180 degrees from the position of the terminal of the connector 12. A shortest distance between the position of the circuit board 14 where the end of the signal line 17 is fitted and the position of the terminal of the connector 12 is a distance between these positions when these rotational positions are aligned in rotation on the axis N. The spare length of the signal line 17 corresponds to the longest distance minus the shortest distance. Since the portion corresponding to the spare length is also secured for the signal line 17, fitting the signal line 17 can be done as easy work.

FIG. 3 illustrates the detector cover 10 rotated 180 degrees after the power line 16 has been fitted to the connector 12 with the power line 16 in the second bracket 6 and the connector 12 being in aligned rotational positions. Starting at a position where the power line 16 is pulled from the second bracket 6 into the interior space of the detector cover 10, the power line 16 is routed nearly half around the detector 11 and is then passed through the detector cover 10 to be connected to the connector 12. The position of the circuit board 14 where the end of the signal line 17 is fitted is in the rotational position moved 180 degrees from the position of the terminal of the connector 12.

It is to be noted that the power line 16 may be wound onto a structure other than the detector 11. The detector cover 10 may be formed with holes that allow passage of the power line 16 in respective positions that are farther from the axis N than its space provided with the detector 11 is. The power line 16 may be wound onto the detector cover 10 while being passed through the holes. The holes that allow the passage of the power line 16 are not limited to the detector cover 10, and such holes may be formed in the second bracket 6. The power line 16 may be wound onto the second bracket 6 while being passed through the holes. The second bracket 6 is one of the structures provided closer to the counter load side than the stator 3 is. Even in each of these cases, the power line 16 can be wound in a position closer to the load side of the electric motor 200 than the circuit board 14 and the signal line 17 are.

According to the second embodiment, the power line 16 is wound in the position closer to the load side of the electric motor 200 than the circuit board 14 and the signal line 17 are. Accordingly, the power line 16 is in the moderately tensioned condition and can be less slack in the electric motor 200. With the power line 16 being less slack, the power line 16 can be prevented from touching or being in close proximity to the signal line 17 or the circuit board 14. In the electric motor 200, an electrical signal that propagates in the signal line 17 can be less contaminated by noise from the power line 16. Therefore, the electric motor 200 enables the electrical signal indicating a detection result of the detector 11 to be less contaminated by the noise.

FIG. 4 illustrates structure of an electric motor 201 according to a modification of the second embodiment. The electric motor 201 according to the modification is not only similar in structure to the electric motor 200 illustrated in FIG. 3, but also is provided with the brake 20 that brakes rotation of the shaft 1, and the brake line 21 connected to the brake 20.

In the electric motor 201, not only the power line 16 but also the brake line 21 is passed around the detector 11 in an interior space of the detector cover 10. The brake line 21 also includes a secured portion corresponding to a spare length similar to that of the power line 16. Since the portion corresponding to the spare length is secured for the brake line 21, fitting the brake line 21 to the connector 12 can be done as easy work. Even when the brake line 21 is in close proximity to the signal line 17, an electrical signal propagating in the signal line 17 is less affected, so that the brake line 21 can be disposed in any position. Therefore, even the electric motor 201 according to the present modification enables the electrical signal indicating a detection result of the detector 11 to be less contaminated by noise.

When the electric motor 201 is provided with a thermistor, a thermistor line can be provided as with the brake line 21. Moreover, a signal line that allows propagation of an electrical signal from a sensor other than the thermistor may also be provided as with the brake line 21 in the electric motor 201.

The above structures illustrated in the embodiments are illustrative of contents of the present invention, can be combined with other techniques that are publicly known and can be partly omitted or changed without departing from the gist of the present invention.

### REFERENCE SIGNS LIST

1 shaft; 2 rotor; 3 stator; 4 first bracket; 5 frame; 6 second bracket; 7 first bearing; 8 second bearing; 9 plate spring; 10 detector cover; 11 detector; 12 connector; 13 disk; 14 circuit board; 15 housing; 16 power line; 17 signal line; 20 brake; 21 brake line; 100, 101, 200, 201 electric motor; N axis.

1. An electric motor that includes a stator, and a rotor to rotate on a shaft, the rotor being surrounded by the stator, the electric motor comprising:
a detector to detect a rotational position of the shaft and to output an electrical signal indicative of a detection result;
a detector cover to house the detector;
a power line provided in the electric motor to transmit electric power that drives rotation of the rotor;
a signal line that allows in the detector cover propagation of the electrical signal output from the detector; and
a connector provided to the detector cover, the connector being fitted with an end of the power line and an end of the signal line, wherein
the signal line is provided in the detector cover without being pulled out of the detector cover,
the detector includes circuitry to output the electrical signal, and
the power line is positioned closer to a load side of the electric motor than the circuitry is.

2. (canceled)

3. The electric motor according to claim 1, wherein the connector is fitted with the end of the power line at a position that is closer to the load side of the electric motor than a signal line fitting position of the connector is.

4. The electric motor according to claim 1, wherein
the detector cover is a cylindrical body, and
the connector is provided to a side surface of the detector cover.

5. The electric motor according to claim 3, wherein in a position that is closer to the load side than the circuitry and the signal line are, the power line is wound onto a structure that is provided closer to a counter load side of the electric motor than the stator is.

6. The electric motor according to claim 5, wherein the structure is the detector.

7. The electric motor according to claim 1, wherein a conductive material is used as a material of the detector cover.

8. The electric motor according to claim 1, wherein a ferromagnetic material is used as the material of the detector cover.
